(19) United States
(12) Patent Application Publication
(10) Pub. No.: US 2014/0241752 A1
(43) Pub. Date: Aug. 28, 2014

(54) DEVELOPER STORAGE CONTAINER, DEVELOPING DEVICE AND IMAGE FORMING APPARATUS

(71) Applicant: OKI DATA CORPORATION, Tokyo (JP)

(72) Inventor: Yoshihiro GOTO, Tokyo (JP)

(73) Assignee: OKI DATA CORPORATION, Tokyo (JP)

(21) Appl. No.: 14/189,498

(22) Filed: Feb. 25, 2014

(30) Foreign Application Priority Data
Feb. 27, 2013 (JP) 2013-036838

(51) Int. Cl. G03G 15/08

(52) U.S. Cl. CPC G03G 15/0881
USPC 399/106

(57) ABSTRACT

A developer storage container includes a first storage member storing a developer, a second storage member fitted to the first storage member, and a sealing member that seals between the first storage member and the second storage member for preventing leakage of the developer. The first storage member includes a first fitting portion. The second storage member includes a second fitting portion fitted to the first fitting portion. The first fitting portion includes a pressing portion pressing the sealing member. The pressing portion includes an inclined portion that faces the second fitting portion.

### BACKGROUND OF THE INVENTION

The present invention relates to a developer storage container, a developing device and an image forming apparatus.

Japanese Laid-open Patent Publication No. 2007-26511 discloses a developer cartridge storing a developer. The developer cartridge is provided with a sealing member for preventing leakage of the developer.

Recently, a developer storage container (such as a developer cartridge) is required to be large in capacity and required to be transported for a long time. For this reason, there is a demand for enhancing a sealing performance.

### SUMMARY OF THE INVENTION

An aspect of the present invention is intended to provide a developer storage container, a developing device and an image forming apparatus having a high sealing performance.

According to an aspect of the present invention, there is provided a developer storage container including a first storage member storing a developer, a second storage member fitted to the first storage member, and a sealing member that seals between the first storage member and the second storage member for preventing leakage of the developer. The first storage member includes a first fitting portion. The second storage member includes a second fitting portion fitted to the first fitting portion. The first fitting portion includes a pressing portion pressing the sealing member. The pressing portion includes an inclined portion that faces the second fitting portion.

With such a configuration, it becomes possible to provide a developer storage container, a developing device and an image forming apparatus having a high sealing performance.

According to still another aspect of the present invention, there is provided a developing device including the above described developer storage container, and a developing member that develops a latent image using the developer supplied by the developer storage container.

According to yet another aspect of the present invention, there is provided an image forming apparatus including an image bearing body, a latent image forming unit that forms a latent image on the image bearing body, the above described developer storage container, and a developing member that develops a latent image using the developer supplied by the developer storage container.

Further scope of applicability of the present invention will become apparent from the detailed description given hereinafter. However, it should be understood that the detailed description and specific embodiments, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

In the attached drawings:

FIG. 1 is a schematic view showing a configuration of an image forming apparatus according to Embodiment 1;

FIG. 2 is a schematic view showing a configuration of an image forming unit according to Embodiment 1;

FIG. 3 is a perspective view showing an external shape of a toner cartridge according to Embodiment 1;

FIG. 4 is a longitudinal sectional view showing the toner cartridge shown in FIG. 3 and a toner stored therein;

FIG. 5 is a longitudinal sectional view showing the toner cartridge shown in FIG. 3 with the toner omitted;

FIG. 6 is a perspective view showing the toner cartridge according to Embodiment 1 before a container main body and a lid member fitted to each other;

FIG. 7 is an enlarged sectional view showing an fitting section between the container main body and the lid member shown in FIG. 5;

FIG. 8 is an enlarged sectional view showing the fitting section shown in FIG. 5 before the container main body and the lid member fitted to each other;

FIG. 9 is an enlarged sectional view showing a tip portion of the container main body in the fitting section according to Embodiment 1;

FIG. 10 is a side view of the lid member according to the Embodiment 1 to which a sealing member is mounted as seen in a direction shown by an arrow F in FIG. 6;

FIG. 11 is a schematic view showing a state where a pressing surface contacts the sealing member while the container main body and the lid member are being fitted to each other;

FIG. 12 is a schematic view for illustrating a function of the pressing surface according to Embodiment 1;

FIG. 13 is a schematic view showing a configuration of a fitting section of a toner cartridge according to Comparison Example;

FIG. 14 is a schematic view showing a configuration of a fitting section of a toner cartridge according to another Comparison Example;

FIG. 15 is a schematic view showing a first modification of the pressing surface according to Embodiment 1;

FIG. 16 is a schematic view showing a second modification of the pressing surface according to Embodiment 1;

FIG. 17 is a schematic view showing a force applied from the inclined surface to the sealing member;

FIG. 18 is a schematic view showing a third modification of the pressing surface according to Embodiment 1;

FIG. 19 is a schematic view showing a fourth modification of the pressing surface according to Embodiment 1;

FIG. 20 is a schematic view showing a fifth modification of the pressing surface according to Embodiment 1;

FIG. 21 is a schematic view showing a sixth modification of the pressing surface according to Embodiment 1;

FIG. 22 is a schematic view showing a seventh modification of the pressing surface according to Embodiment 1;

FIG. 23 is a schematic view showing a configuration of a fitting section of a toner cartridge according to Embodiment 2;

FIG. 24 is a schematic view showing a configuration of a fitting section of a toner cartridge according to Embodiment 3; and

FIG. 25 is a schematic view showing a modification of a fitting section of the toner cartridge according to Embodiment 3.

### DETAILED DESCRIPTION OF THE PREFERRED EMBODIMENT

Hereinafter, embodiments of the present invention will be described with reference to drawings. The present invention is not limited to the embodiments described below. The embodiments can be modified without departing the scope of the present invention.

### Embodiment 1

### Configuration of Image Forming Apparatus

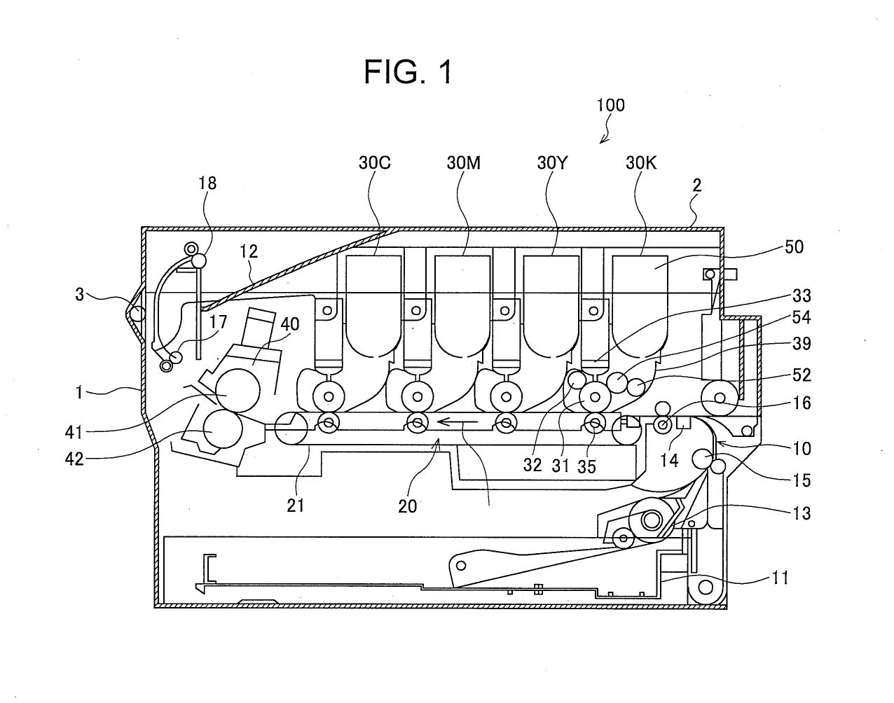

FIG. 1 is a schematic sectional view showing a configuration of an image forming apparatus 100 according to Embodiment 1. The image forming apparatus 100 is configured to form an image on a recording medium using a developer. Here, the image forming apparatus 100 is configured as a color printer that forms a color image using developers (i.e., toners) of Black (K), Yellow (Y), Magenta (M) and Cyan (C).

The image forming apparatus 100 includes a lower frame 1 and a top cover 2 provided above the lower frame 1.

A medium conveying path 10 having a substantially “S”-shape is provided in the lower frame 1. A recording medium (i.e., a recording sheet) is conveyed along the medium conveying path 10. Medium conveying rollers 15, 16, 17 and 18 are provided along the medium conveying path 10. The recording medium is conveyed in a direction shown by an arrow C (i.e., a conveying direction) along the medium conveying path 10. A medium cassette 11 is provided on an upstream end of the medium conveying path 10 in the conveying direction. The medium cassette 11 stores a stack of the recording media (i.e., the recording sheets). A stacker 12 is provided on a downstream end of the medium conveying path 10 in the conveying direction. The printed recording media are placed on the stacker 12.

Along the medium conveying path 10, a medium feeding unit 13, a detection unit 14, and a transfer belt unit 20 are arranged in this order from upstream to downstream in the conveying direction. The medium feeding unit 13 feeds the recording medium from the medium cassette 11. The medium conveying rollers 15 and 16 convey the medium toward the transfer belt unit 20. The detection unit 14 detects a thickness of the recording medium. The transfer belt unit 20 includes a transfer belt 21. The transfer belt 21 electrostatically absorbs the recording medium, and conveys the recording medium.

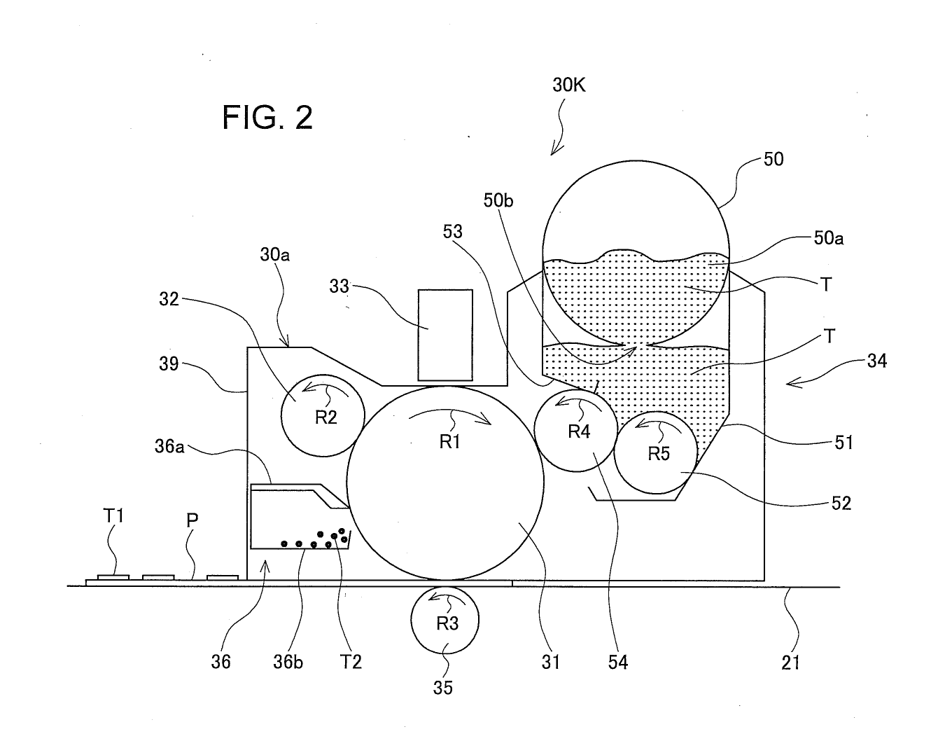

Image forming units 30K, 30Y, 30M and 30C are provided above the transfer belt unit 20 so as to sandwich the recording medium between the image forming units 30K, 30Y, 30M and 30C and the transfer belt 21. The image forming units 30K, 30Y, 30M and 30C are collectively referred to as the image forming units 30 as necessary. The image forming units 30K, 30Y, 30M and 30C respectively stores toners (i.e., developers) of Black (K), Yellow (Y), Magenta (M) and Cyan (C), and form toner images on the recording medium using the respective toners. The image forming units 30K, 30Y, 30M and 30C are detachably mounted to a main body of the image forming apparatus 100. In this regard, the main body of the image forming apparatus 100 is a part of the image forming apparatus 100 from which detachable components are detached. Similarly, an image forming unit main body 3a (FIG. 2) is a part of the image forming unit 30 from which a detachable component (such as a toner cartridge) is detached.

A fixing unit 40 is provided in the lower frame 1. The fixing unit 40 is disposed downstream of the transfer belt unit 20 in the medium conveying direction. The fixing unit 40 fixes the toner image to the recording medium conveyed from the transfer belt unit 20. The fixing unit 40 includes a heat roller 41 and a backup roller 42 pressed against the heat roller 41. The fixing unit 40 fixes the toner image to the recording medium by applying heat and pressure to the toner. The medium conveying rollers 17 and 18 convey the recording medium (to which the toner image is fixed) to the stacker 12.

The top cover 2 is supported by the lower frame 1 so that the top cover 2 is swingable about a swinging axis 3. In other words, the top cover 2 is swingable so as to open and close an upper part of the lower frame 1. The image forming units 30, the fixing unit 40 and the transfer belt unit 20 can be replaced by opening the top cover 2.

### <Configuration of Image Forming Unit>

FIG. 2 is a schematic view showing a configuration of the image forming unit 30K. The configuration of the image forming unit 30K will be described with reference to FIG. 2. The image forming units 30Y, 30M and 30C have the same configuration as the image forming unit 30K except the toner. Therefore, descriptions of the configurations of the image forming units 30Y, 30M and 30C will be omitted.

As shown in FIG. 2, the image forming unit 30K includes a photosensitive body 31 (i.e., an image bearing body). The photosensitive body 31 is formed of, for example, a photosensitive drum having a cylindrical shape. The photosensitive body 31 is rotatable in a direction shown by an arrow R1. Along a circumference of the photosensitive body 31, a charging roller 32 (i.e., a charging member), an exposure unit 33 (i.e., a latent image forming unit), a developing device 34, a transfer roller 35 (i.e., a transfer unit) and a cleaning unit 36 are provided in this order in a rotating direction of the photosensitive body 31. The photosensitive body 31, the charging roller 32, the developing device 34 and the cleaning unit 36 are included in the image forming unit 30K. The exposure unit 33 is mounted to the top cover 2. The transfer roller 35 is included in the transfer belt unit 20 mounted to the lower frame 1 (see FIG. 1).

The charging roller 32 is configured to supply an electric charge to a surface of the photosensitive body 31 so as to uniformly charge the surface of the photosensitive body 31. The charging roller 32 is pressed against the surface of the photosensitive body 31 with a constant pressure, and rotates in a direction shown by an arrow R2 in FIG. 2. The exposure unit 33 is constituted by, for example, an LED head. The exposure unit 33 emits light so as to expose the uniformly charged surface of the photosensitive body 31 to form a latent image. The developing device 34 develops the latent image on the surface of the photosensitive body 31 by causing the toner T of a predetermined color (in this case, black) to adhere to the surface of the photosensitive body 31.

The transfer roller 35 is configured to transfer the toner image from the surface of the photosensitive body 31 to the recording medium (shown by mark P in FIG. 2). The transfer roller 35 includes a roller part composed of an electrically-conductive rubber or the like. The transfer roller 35 is pressed against the photosensitive body 31 via the transfer belt 21, and rotates in a direction as shown by an arrow R3 in FIG. 2. The transfer roller 35 is applied with a voltage (i.e., a charging voltage) so as to generate a difference in electrical potential between the surface of the photosensitive body 31 and the surface of the transfer roller 35. With the electrical potential, the toner image is transferred from the surface of the photosensitive body 31 to the recording medium P. The toner (indicated by mark T1) transferred to the recording medium P is fixed to the recording medium P by the fixing unit 40.

The cleaning unit 36 is configured to remove the toner (referred to as a residual toner T2) that removes on the surface of the photosensitive body 31 after the toner image is transferred to the recording medium P. The cleaning unit 36 includes a cleaning blade 36a that scrapes off the residual toner T2 from the surface of the photosensitive body 31, and a waste toner collecting unit 36b storing the residual toner T2 having been scraped off from the surface of the photosensitive body 31. The cleaning blade 36 is formed of a resilient body. An edge portion of the cleaning blade 36 contacts the surface of the photosensitive body 31 with a constant pressure.

Next, a configuration of the developing device 34 will be described.

The developing device 34 includes a toner cartridge 50 (i.e., a developer storage container), a toner reservoir 51 (i.e., a developer holding portion), a toner supplying roller 52 (i.e., a developer supplying member), a developing blade 53 (i.e., a developer regulating member), and a developing roller 54 (i.e., a developing member or a developer bearing body).

The toner cartridge 50 is a container for storing the toner T as a developer. The toner cartridge 50 includes a toner storage chamber 50a (i.e., a developer storage chamber) in which the toner T is stored, and a toner ejection opening 50b (i.e., a developer ejection opening) through which the toner T is ejected outside. The toner ejection opening 50b is formed on a bottom of the toner cartridge 50.

The toner reservoir 51 is provided below the toner cartridge 50, and stores the toner T supplied (ejected) from the toner cartridge 50. The toner supplying roller 52 supplies the toner T in the toner reservoir 51 to the developing roller 54. The developing blade 53 forms a thin toner layer having a constant thickness on a surface of the developing roller 54. The developing roller 54 develops the latent image on the surface of the photosensitive body 31 using the toner T supplied by the toner cartridge 50. More specifically, the developing roller 54 is pressed against the photosensitive body 31 with a constant pressure, and develops the latent image on the surface of the photosensitive body 31 using the toner.

The toner cartridge 50 is detachably mounted to an image forming unit main body 30a at a portion above the toner reservoir 51 and the toner supplying roller 52. In this regard, the image forming unit main body 30a is a part of the image forming unit 30K from which the toner cartridge 50 is removed. The image forming unit main body 30a has a mold 39 that constitutes an enclosure. The developing roller 54 and the toner supplying roller 52 are disposed in parallel to each other. The developing roller 54 and the toner supplying roller 52 contact each other with a constant pressure. The developing roller 54 and the toner supplying roller 52 rotate in the same directions as respectively shown by arrows R4 and R5. The developing roller 54 and the developing blade 53 are disposed in parallel to each other as shown in FIG. 2. For example, a bent portion of the developing blade 53 contacts the surface of the developing roller 54 with a constant pressure.

The photosensitive body 31, the charging roller 32, the developing roller 54 and other rotating bodies of the image forming apparatus 100 are rotated by a power transmitted from driving sources (not shown) via gears.

### <Configuration of Toner Cartridge>

Hereinafter, a configuration of the toner cartridge 50 will be described in detail.

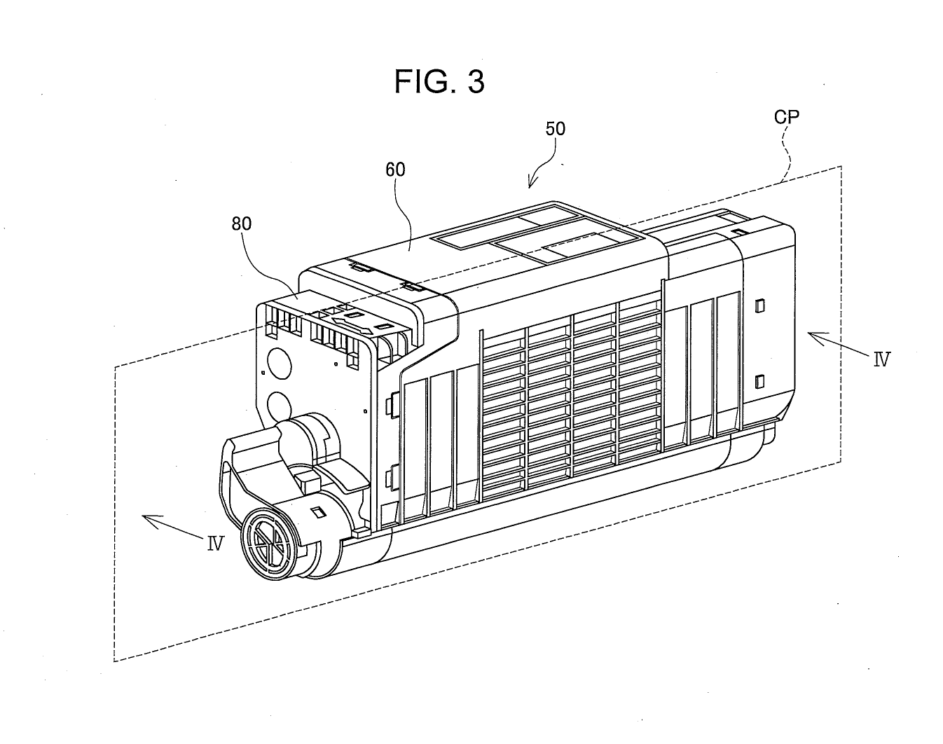

FIG. 3 is a perspective view showing an external shape of the toner cartridge 50. As shown in FIG. 3, the toner cartridge includes a container main body 60 (i.e., a first storage member) and a lid member 80 (i.e., a second storage member or a side lid). The toner cartridge 50 is assembled by fitting the container main body 60 and the lid member 80 to each other, or by causing the container main body 60 and the lid member 80 to engage each other.

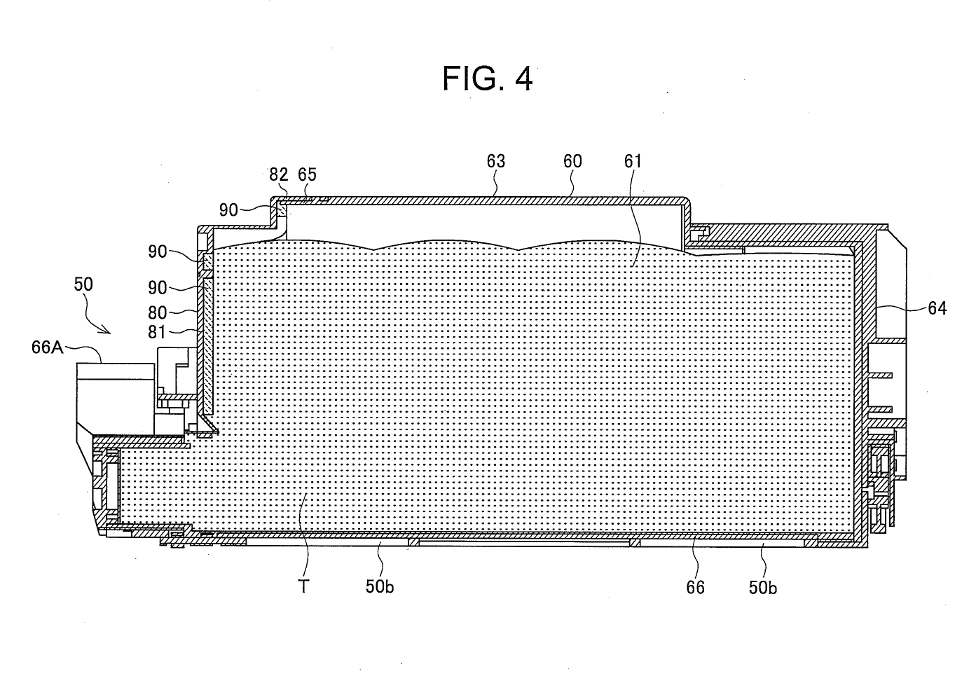

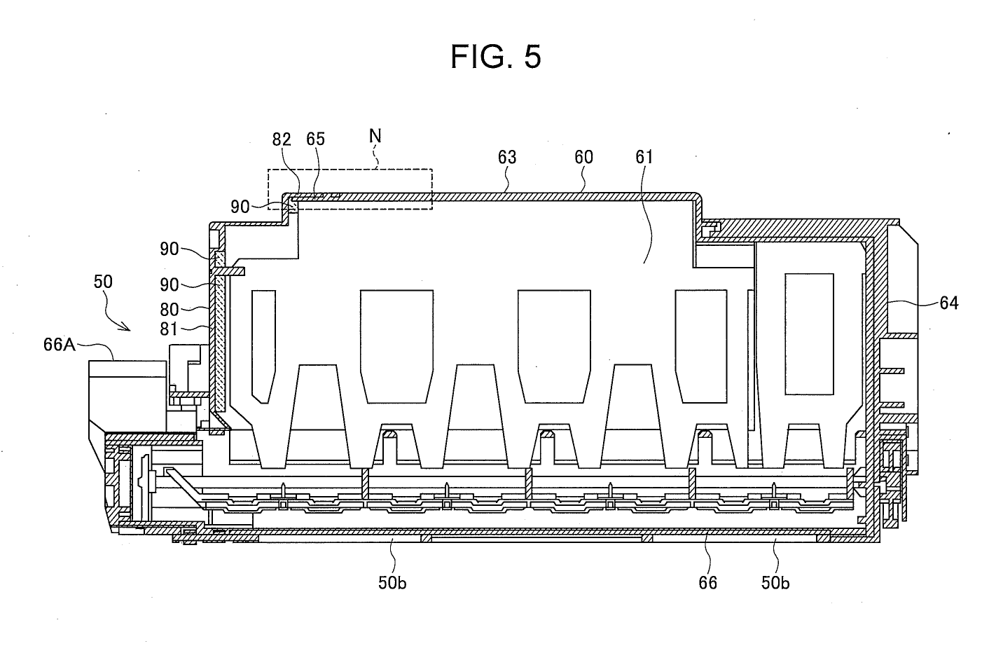

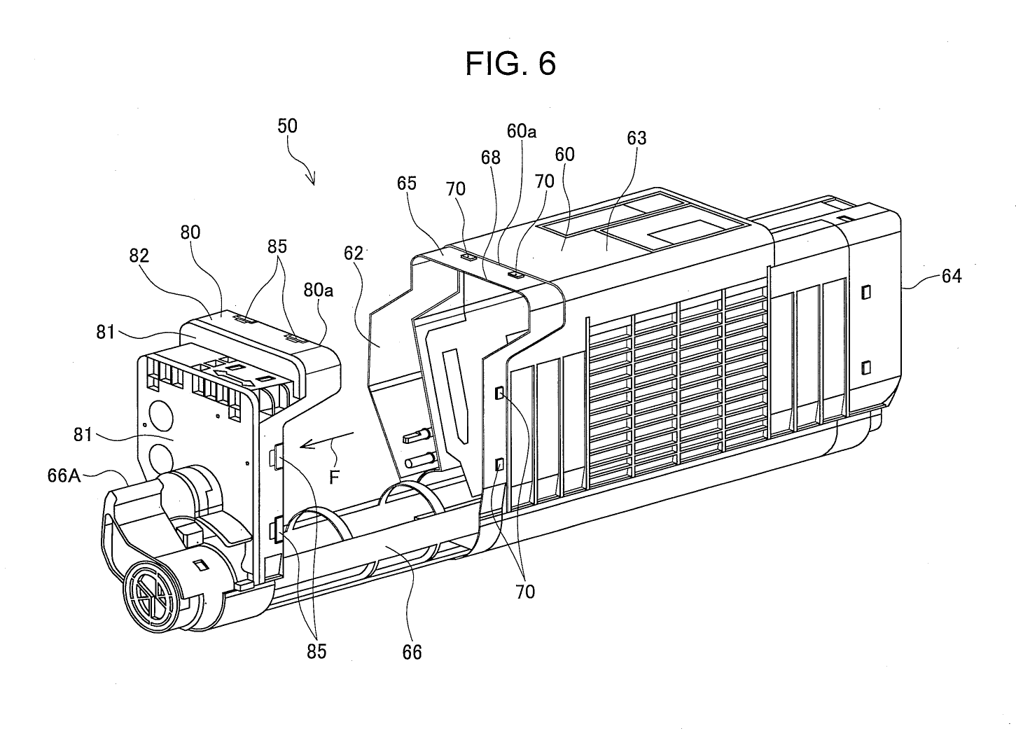

FIGS. 4 and 5 are longitudinal sectional views of the toner cartridge 50 cut along a plane CP as seen in a direction indicated by an arrow IV. The toner T stored in the toner cartridge 50 is shown in FIG. 4, but is omitted in FIG. 5. FIG. 6 is a perspective view showing an external shape of the toner cartridge 50 before the container main body 60 and the lid member 80 are fitted to each other. Hereinafter, a direction in which the container main body 60 is fitted into the lid member 80 is referred to as a fitting-in direction. The fitting-in direction is shown by an arrow F in FIG. 6.

The container main body 60 is a container for storing the toner T therein. The container main body 60 includes an inner space 61 that constitutes the toner storage chamber 50a, and an opening 62 leading to the inner space 61. More specifically, the container main body 60 includes a surrounding wall portion 63 that encloses the inner space 61 and extends in the fitting-in direction. The opening 62 is formed on an end of the surrounding wall portion 63 in the fitting-in direction. The opening 62 faces the fitting-in direction. A side wall portion 64 is formed on the other end of the surrounding wall portion 63. In other words, the side wall portion 64 closes the other end (i.e., an end opposite to the opening 62) of the surrounding wall portion 63. The container main body 60 has a substantially rectangular U-shaped cross section when cut along a plane perpendicular to the fitting-in direction.

The container main body 60 includes a fitting-in portion 65 (i.e., a first fitting portion) fitted to the lid member 80. More specifically, the fitting-in portion 65 is fitted into inside of the lid member 80. The fitting-in portion 65 is formed on the end of the container main body 60 in the fitting-in direction (i.e., the same end as the opening 62).

The toner ejection opening 50b is formed on the bottom of the container main body 60 (more specifically, the surrounding wall portion 63). The toner ejection opening 50b is provided for ejecting the toner T stored in the inner space 61. A shutter member 66 is provided on a lower part of the inner space 61. The shutter member 66 opens and closes the toner ejection opening 50b. A lever member 66A is fixed to the shutter member 66 for rotating the shutter member 66. By rotating the lever member 66A, the shutter member 66 rotates with respect to the container main body 60 to open and close the toner ejection opening 50b.

The lid member 80 is fitted to the container main body 60 so as to close the inner space 61. The lid member 80 is mounted to the container main body 60 so as to close the opening 62. More specifically, the lid member 80 includes a side wall portion facing the opening 62, and a surrounding wall portion 82 extending from a periphery of the side wall portion 81. The surrounding wall portion 82 extends in the fitting-in direction toward the container main body 60, and is fitted to the fitting-in portion 65. The lid member 80 has a substantially rectangular U-shaped cross section when cut along a plane perpendicular to the fitting-in direction.

A sealing member 90 is provided between the container main body 60 and the lid member 80 for preventing leakage of the toner T in the inner space 61. The sealing member 90 seals between the container main body 60 and the lid member 80, and has a function to prevent leakage of the toner T from the toner cartridge 50.

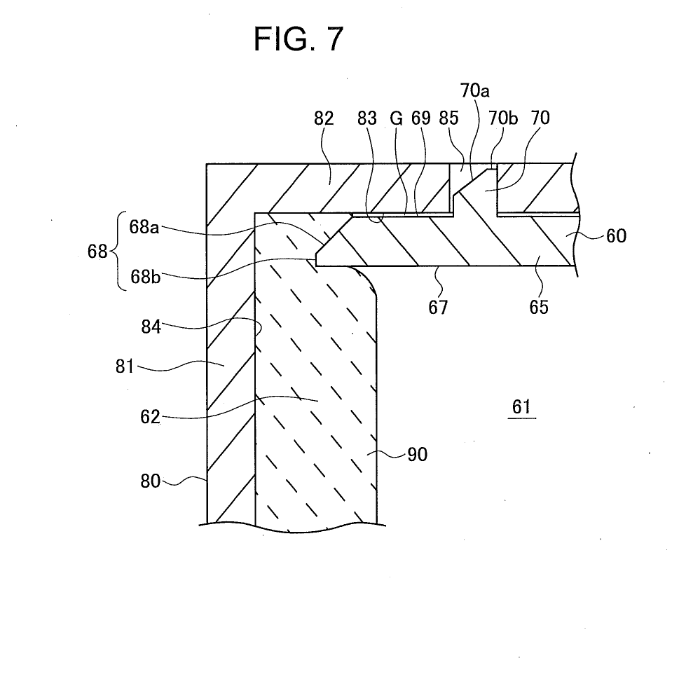

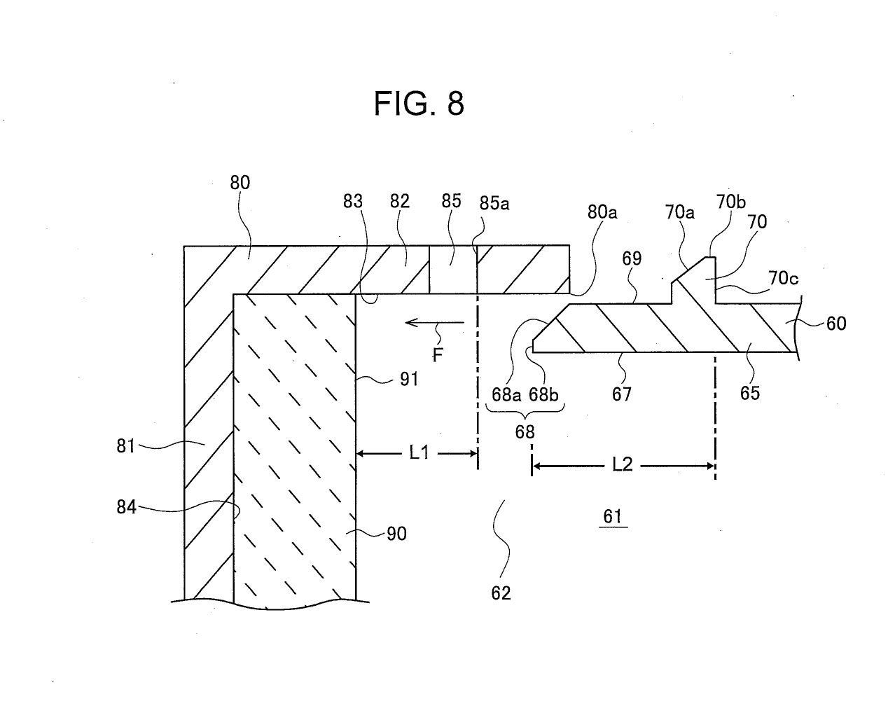

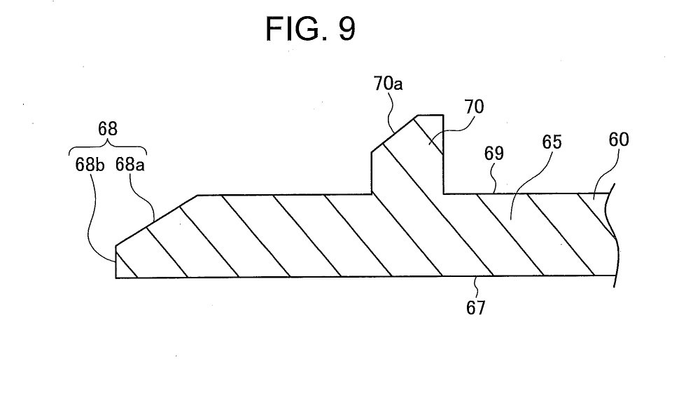

FIG. 7 is an enlarged view of a fitting section N which is shown by a dashed line in FIG. 5. FIG. 8 is an enlarged view of the fitting section N (FIG. 5) before the container main body 60 and the lid member 80 are fitted to each other. FIG. 9 is an enlarged view showing a tip portion of the container main body 60 in the fitting section N. FIG. 10 is a side view showing the lid member 80 to which the sealing member 90 is mounted as seen in the fitting-in direction shown by the arrow F in FIG. 6. In FIG. 10, the sealing member 90 is obliquely hatched. A fitting structure of the container main body 60 and the lid member 80 will be described with reference to FIGS. 7 through 10.

As shown in FIGS. 7 and 8, the surrounding wall 82 of the lid member 80 has a fitting surface 83 (i.e., a second fitting portion or an extending surface) to which the fitting-in portion 65 of the container main body 60 is fitted. More specifically, the lid member 80 has a bottom surface 84 (i.e., a lid surface) facing the opening 62. The fitting surface 83 extends from the bottom surface 84 toward the container main body 60. In this example, the fitting surface 83 extends in the fitting-in direction. The bottom surface 84 is perpendicular to the fitting-in direction (in other words, perpendicular to the fitting surface 83). The fitting surface 83 is an inner wall surface of the surrounding wall portion 82. The bottom surface 84 is an inner wall surface of the side wall portion 81. The side wall portion 81 and the bottom surface 84 are formed at an end of the toner cartridge 50 in the fitting-in direction.

The sealing member 90 is provided so as to contact the bottom surface 84 and the fitting surface 83 of the lid member 80. The sealing member 90 (i.e., a resilient member) is formed of a resilient material. In this example, the sealing member 90 is formed of a sponge. The sealing member 90 has a constant thickness, and is fixed (more specifically, bonded) to the bottom surface 84 of the lid member 80.

The fitting-in portion 65 of the container main body 60 extends in the fitting-in direction. The fitting-in portion 65 includes an inner wall surface 67, a pressing surface 68 (i.e., a pressing portion) and an outer wall surface 69.

The inner wall surface 67 extends toward the bottom surface 84 of the lid member 80. The inner wall surface 67 defines the inner space 61, and holds the toner T stored in the inner space 61. In this example, the inner wall surface 67 is parallel to the fitting surface 83. The inner wall surface 67 is perpendicular to the bottom surface 84.

The pressing surface 68 is a surface pressed against the sealing member 90. More specifically, the pressing surface 68 is formed continuously with the inner wall surface 67. The pressing surface 68 contacts the sealing member 90 to compress the sealing member 90 between the pressing surface 68 and the lid member 80. The pressing surface 68 is an end surface of the container main body 60 located on the same side as the opening 62. In other words, the pressing surface 68 is formed on a downstream end of the container main body 60 in the fitting-in direction. Further, the pressing surface 68 is disposed downstream of a latch 70 (described later) in the fitting-in direction. A direction in which the pressing surface 68 presses the sealing member 90 is parallel to the fitting-in direction.

In order to achieve a high sealing performance, the pressing surface 68 has an inclined surface 68a that faces the fitting surface 83 via the sealing member 90. The inclined surface 68a is inclined so that a distance between the inclined surface 68a and the fitting surface 83 increases toward the opening 62 (or toward the sealing member 90). The pressing surface 68 has a tip portion 68b (i.e., an end portion) disposed at a tip of the container maim body 60 facing the lid member 80. As shown in FIG. 8, the pressing surface 68 contacts a contact surface 91 of the sealing member 90. The tip portion 68b is parallel to the contact surface 91 of the sealing member 90 before the sealing member 90 is compressed and deformed. In this example, the tip portion 68b is a plane that faces the bottom surface 84. Further, the tip portion 68b extends in a direction perpendicular to the fitting-in direction, the fitting surface 83 and the inner wall surface 67.

The outer wall surface 69 is formed continuously with the pressing surface 68. The outer wall surface 69 is formed on a side opposite to the inner wall surface 67. The outer wall surface 69 faces the fitting surface 83 of the lid member 80. The outer wall surface 69 and the fitting surface 83 are disposed proximate to each other, and a gap G is formed between the outer wall surface 69 and the fitting surface 83. The gap G is isolated from the inner space 61 by the sealing member 90.

Further, the container main body 60 includes a latch 70 as a first engaging portion. The lid member 80 includes a hole 85 as a second engaging portion that engages the latch 70. The latch 70 and the hole 85 engage each other in a state where the sealing member 90 contacts the pressing surface 68. More specifically, when the latch 70 and the hole 85 engage each other, the pressing surface 68 contacts the sealing member 90 while compressing the sealing member 90. By engagement between the latch 70 and the hole 85, relative positions of the container main body 60 and the lid member 80 are determined. The latch 70 is a convex that protrudes from the outer wall surface 69 toward the fitting surface 83. The hole 85 is a concave receding from the fitting surface 83 in a direction away from the outer wall surface 69. The latch 70 has an inclined portion 70a. The inclined portion 70a is inclined with respect to the outer wall surface 69 so that a height (i.e., a protruding amount) from the outer wall surface 69 increases toward an upstream side in the fitting-in direction. The hole 85 is a through hole penetrating the surrounding wall portion 82. In this example, as shown in FIG. 6, four latches 70 and four holes 85 are provided. However, the number of the latch (latches) 70 and the hole (holes) 85 are not limited.

The container main body 60 has a facing surface 60a (FIG. 6) formed on an upstream end of the fitting-in portion 65 in the fitting-in direction. The facing surface 60a faces and contacts an end portion 80a (FIG. 6) of the lid member 80. The end portion 80a is formed on an upstream end of the lid member 80 in the fitting-in direction.

In FIG. 8, an end of the hole 85 on an upstream side in the fitting-in direction (shown by the arrow F) is referred to as an upstream end 85a. An end of the latch 70 on the upstream side in the fitting-in direction (shown by the arrow F) is referred to as an upstream end 70c. Further, “L1” indicates a distance from the contact surface 91 of the sealing member 90 to the upstream end 85a of the hole 85. “L2” indicates a distance from the tip portion 68b to the upstream end 70c of the latch 70. The distance L1 is shorter than the distance L2 (i.e., L1<L2). Therefore, while the container main body 60 and the lid member 80 are being fitted to each other, the tip portion 68b contacts the contact surface 91 of the sealing member, 90 before the latch 70 engages the hole 85.

### <Operation of Image Forming Apparatus>

A printing operation of the image forming apparatus 100 will be described with reference to FIG. 1.

When the image forming apparatus 100 receives print command from a host device (not shown), the image forming apparatus 100 causes the medium feeding unit 13 to feed the recording medium from the medium cassette 11. The medium conveying rollers 15 and 16 convey the recording medium along the medium conveying path 10 toward the transfer belt unit 20. The detection unit 14 detects the thickness of the recording medium. In the transfer belt unit 20, the transfer belt 21 coveys the recording medium in the direction shown by the arrow C. When the recording medium is conveyed through the image forming units 30K, 30Y, 30M and 30C, the toner images of the respective colors are transferred to a recording surface of the recording medium. Then, the transfer belt 21 conveys the recording medium to the fixing unit 40, and the fixing unit 40 fixes the toner image to the recording surface of the recording medium. Then, the medium conveying rollers 17 and 18 convey the recording medium to the stacker 12.

A toner image formation in the above described printing operation will be described with reference to FIG. 2. The toner image formation described below is controlled by, for example, a control unit (not shown) of the image forming apparatus 100.

The photosensitive body 31 rotates in the direction indicated by the arrow R1. The surface of the photosensitive body 31 is uniformly charged by the charging roller 32. Then, the surface of the photosensitive body 31 is exposed with light emitted by the exposure unit 33 so that a latent image is formed on the surface of the photosensitive body 31 according to image information. In the developing device 34, the toner T is supplied from the toner cartridge 50 and is held in the toner reservoir 51. The toner T is supplied by the toner supplying roller 52 to the developing roller 54. The toner T supplied to the developing roller 54 is formed into the thin toner layer having a constant thickness by the developing blade 53. The latent image on the surface of the photosensitive body 31 is developed by the toner T on the surface of the developing roller 54, and a toner image (i.e., a developer image) is formed on the surface of the photosensitive body 31. The toner image on the surface of the photosensitive body 31 is transferred to the recording medium P by the electrical potential difference between the photosensitive body 31 and the transfer roller 35. The residual toner that remains on the surface of the photosensitive body 31 after the toner image is transferred to the recording medium P is removed by the cleaning blade 36a, and is collected in the waste toner collection unit 36b.

### <Assembly of Toner Cartridge>

An assembly of the toner cartridge 50 will be described. The assembly described below is carried out by an operator or manufacturing equipment.

Before the container main body 60 and the lid member 80 are fitted to each other, the toner cartridge 50 is in a state shown in FIG. 6. From this state, the container main body 60 is moved in the fitting-in direction as shown by the arrow F, and the fitting-in portion 65 at the end of the container main body 60 is fitted into inside of the lid member 80. This causes the latch 70 to engage the hole 85. In this way, the container main body 60 and the lid member 80 are fitted to each other as shown in FIG. 3. In this state, the end portion 80a (FIG. 6) of the lid member 80 faces or contacts the facing surface 60a (FIG. 6) of the container main body 60.

Next, an operation of the fitting section N shown in FIG. 5 during the assembly will be described.

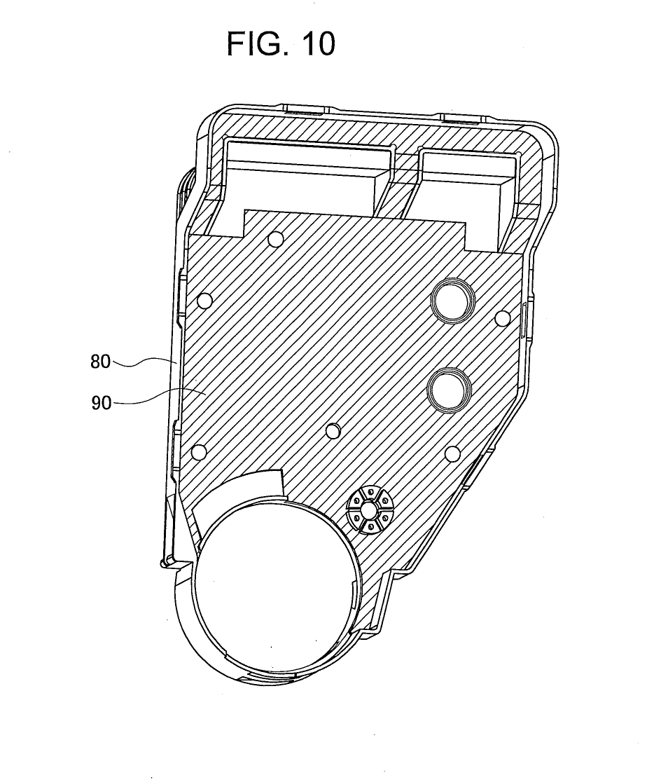

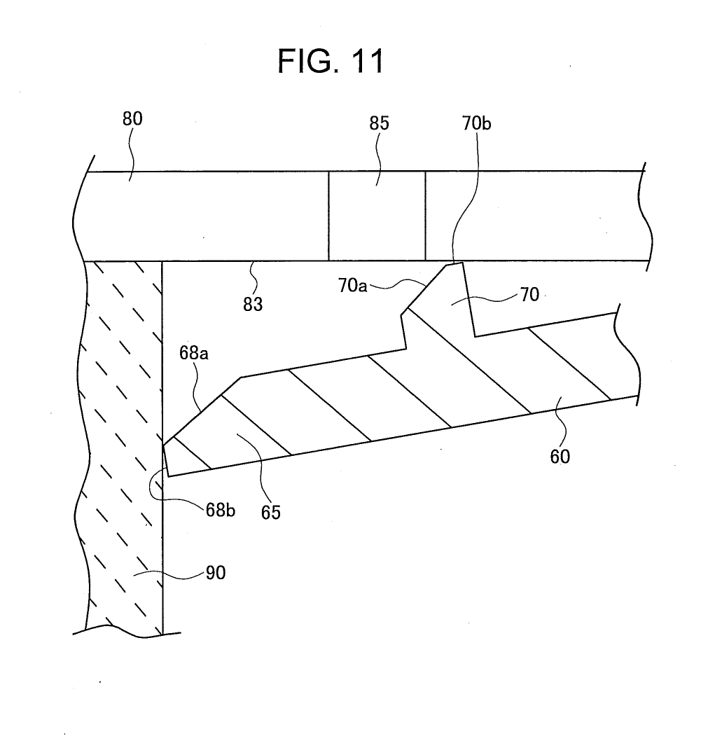

Before the container main body 60 and the lid member 80 are fitted to each other, the container main body 60 and the lid member 80 are in a state shown in FIG. 8. From this state, when the container main body 60 is moved in the fitting-in direction as shown by the arrow F, the tip portion of the fitting-in portion 65 moves into the lid member 80. The inclined surface 70a of the latch 70 contacts the end portion 80a of the lid member 80. When the container main body 60 is further moved in the fitting-in direction, the fitting-in portion 65 further moves into the lid member 80 while the inclined surfaces 70a contacts the end portion 80a. In this state, the container main body 60 is resiliently deformed in a direction in which the pressing surface 68 moves away from the fitting surface 83 by a pushing force from the lid member 80. After the inclined surface 70a passes the end portion 80a, the container main body 60 is further moved in the fitting-in direction while a top portion 70b of the latch 70 slides along the fitting surface 83. Then, the pressing surface 68 contacts the sealing member 90 while the container main body 60 is resiliently deformed as shown in FIG. 11. When the container main body 60 is further moved in the fitting-in direction, the pressing surface 68 is pressed against the sealing member 90 while compressing the sealing member 90, and the latch 70 engages the hole 85. When the latch 70 engages the hole 85, the container main body 60 is released from the pushing force from the lid member 80. Therefore, the container main body 60 moves in a direction in which the pressing surface 68 moves toward the fitting surface 83 by a resilient restoring force of the container main body 60. As a result, the container main body 60 restores its original shape as shown in FIG. 7, and the lid member 80 and the container main body 60 are fixed to each other.

In this way, when the latch 70 moves toward the hole 85, the latch 70 contacts the fitting surface 83, and the container main body 60 resiliently deforms so that the pressing surface 68 moves away from the fitting surface 83. Further, when the latch 70 engages the hole 85, the container main body 60 resiliently restores its original shape, and the pressing surface 68 moves toward the fitting surface 83. Therefore, a gap between the fitting-in portion 65a and the fitting surface 83 is smaller when the latch 70 engages the hole 85 (i.e., when the container main body 60 and the lid member 80 are completely fitted to each other) than while the container main body 60 and the lid member 80 are being fitted to each other.

### <Function of Pressing Surface>

Next, a function of the pressing surface 68 will be described.

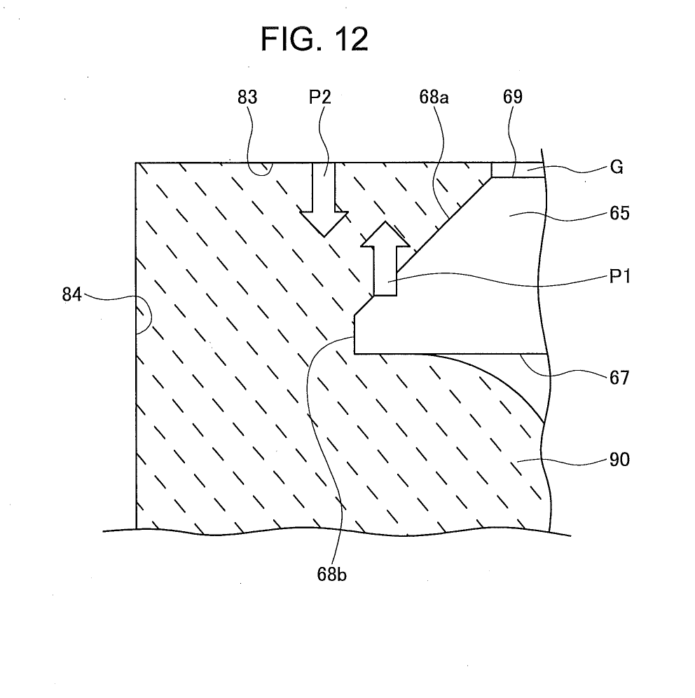

As shown in FIG. 12, the sealing member 90 is compressed by the tip portion 68b of the pressing surface 68 in the fitting-in direction, and is applied with a pressure P1 in a direction from the inclined surface 68a toward the fitting surface 83. The sealing member 90 is also applied with a pressure P2 (i.e., a reactive force from the fitting surface 83) in a direction from the fitting surface 83 toward the inclined surface 68a. Therefore, the sealing member 90 is compressed with a high pressure between the inclined surface 68a and the fitting surface 83. Accordingly, the inclined surface 68a and the sealing member 90 contact each other with a high pressure. In this regard, the inclined surface 68a faces the fitting surface 83 and also faces the bottom surface 84, and therefore the sealing member 90 is compressed between the fitting surface 83 and the bottom surface 84.

In this regard, assuming that leakage of the toner T from the inner space 61 occurs due to a low sealing performance, the toner T may mainly move through a contact portion between the pressing surface 68 and the sealing member 90, move through the gap G, and reach the outside of the toner cartridge 50 through the hole 85.

According to Embodiment 1, the sealing member 90 is compressed between the inclined surface 68a and the fitting surface 83, and the inclined surface 68a contacts the sealing member 90 with a high pressure. Therefore, a leakage path of the toner T leading to the gap G is closed. Thus, the leakage of the toner T is prevented.

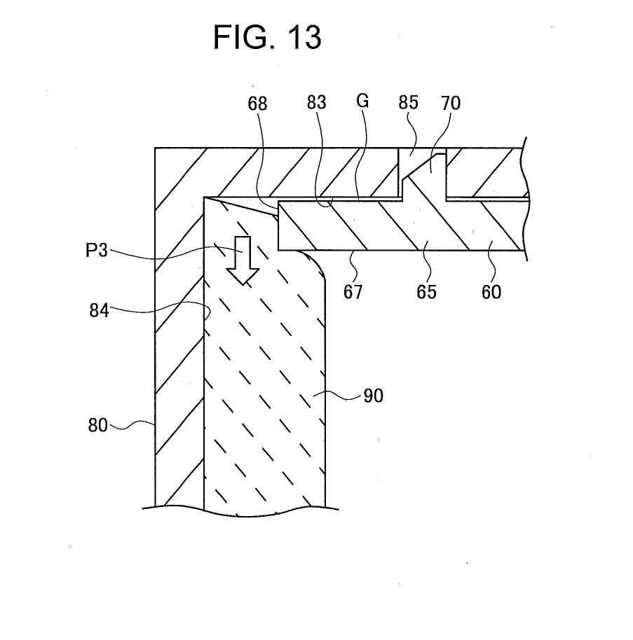

FIG. 13 is a schematic view showing a fitting section of a toner cartridge according to Comparison Example. For convenience of explanation, components corresponding to those of Embodiment 1 are assigned the same reference numerals.

In FIG. 13, the pressing surface 68 has a plane surface perpendicular to the fitting surface 83, but does not have the inclined surface 68a. In this configuration, when the pressing surface 68 is pressed against the sealing member 90, the seal member 90 is applied with a pressure P3 in a direction away from the fitting surface 83. The seal member 90 is not applied with a force P1 as shown in FIG. 12 in a direction toward the fitting surface 83. Therefore, the sealing member 90 is deformed as shown in FIG. 13 by the pressure P3 so that the sealing member 90 moves away from the fitting surface 83. Such a deformation of the sealing member 90 may deteriorate the sealing performance, and may cause the leakage of the toner T. Further, in the configuration shown in FIG. 13, when the pressing surface 68 is pressed against the sealing member 90, the sealing member 90 may escape downward from a portion between the pressing surface 68 and the lid member 80, and a contact pressure between the pressing surface 68 and the sealing member 90 may decrease. Further, an area (i.e., a contact area) at which the pressing surface 68 contacts the sealing member 90 may also decrease. Such decrease in contact pressure and contact area may cause the leakage of the toner.

In contrast, according to Embodiment 1, the seal member 90 is pressed against the fitting surface 83 by the pressure P1 in the direction toward the fitting surface 83 as shown in FIG. 12, and therefore the sealing member 90 is prevented from moving away from the fitting surface 83, with the result that the sealing performance is ensured. Further, the inclined surface 68a presses the sealing member 90 against the fitting surface 83, and therefore the sealing member 90 is prevented from escaping. Accordingly, the decrease in contact pressure and contact area is prevented.

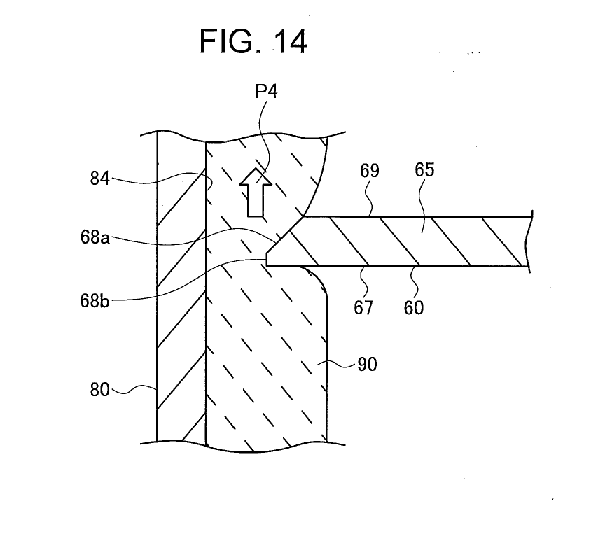

FIG. 14 is a schematic view showing a fitting section of a toner cartridge according to another Comparison Example. For convenience of explanation, components corresponding to those of Embodiment 1 are assigned the same reference numerals.

In a configuration shown in FIG. 14, the lid member 80 has no fitting surface 83. Therefore, the seal member 90 is applied with a pressure P4 by the inclined surface 68a, but is not applied with a pressure in a direction from the fitting surface 83 toward the inclined surface 68a (see, the pressure P2 shown in FIG. 12). Accordingly, a pressure between the sealing member 90 and the inclined surface 68a becomes low, and therefore a high sealing performance is not achieved.

In contrast, according to Embodiment 1, the lid member 80 has the fitting surface 83, and therefore the seal member 90 is applied with the pressure P2 in the direction from the fitting surface 83 toward the inclined surface 68a as shown in FIG. 12. Therefore, the pressure between the sealing member 90 and the inclined surface 68a becomes high, and a high sealing performance is achieved.

In this regard, it is preferred to that the fitting-in portion 65 and the fitting surface 83 are disposed proximate to each other. With such an arrangement, the pressure applied to the sealing member 90 between the fitting surface 83 and the inclined surface 68a increases, and the sealing performance is enhanced.

### Advantages of Embodiment 1

As described above, Embodiment 1 of the present invention provides the following advantages (1) through (4).

(1) In Embodiment 1, the pressing surface 68 has the inclined surface 68a facing the fitting surface 83 via the sealing member 90. Therefore, the sealing performance between the container main body 60 and the lid member 80 can be enhanced, as compared with a configuration in which the inclined surface 68a is not provided. More specifically, the sealing member 90 can be compressed between the inclined surface 68a and the fitting surface 83 with a high pressure, and the inclined surface 68a and the sealing member 90 can be brought into contact with each other with a high pressure. Thus, the sealing performance between the pressing surface 68 and the fitting surface 83 can be enhanced, and the toner can be prevented from entering into the gap G between the fitting surface 83 and the outer wall surface 69. Furthermore, the sealing member 90 can be pressed against the fitting surface 83 by the inclined surface 68a, and therefore the sealing member 90 can be prevented from moving away from the fitting surface 83 and prevented from escaping from a portion between the pressing surface 68 and the lid member 80. Thus, the sealing performance can be enhanced. As a result, even when the toner cartridge 50 has a large capacity or is transported for a long time, the leakage of the toner from the toner cartridge 50 can be surly prevented.

(2) The pressing surface 68 has the tip portion 68b contacting the sealing member 90. The tip portion 68b extends in parallel to the surface of the sealing member 90 before the sealing member 90 is compressed and deformed. With such a configuration, concentration of the pressure applied to the sealing member 90 can be prevented, as compared with a configuration in which the tip portion 68b has an acute-angled portion. Accordingly, a load on the sealing member 90 can be reduced.

(3) The pressing surface 68 does not have a surface (i.e., a reversely inclined surface) which is inclined so that a distance from the fitting surface 83 decreases toward the opening 62. Therefore, the sealing member 90 is prevented from being applied with a pressure in a direction away from the fitting surface 83. Therefore, a decrease in sealing performance (due to the pressure in the direction away from the fitting surface 83) can be prevented. More specifically, if the pressing surface 68 has the reversely inclined surface, the sealing member 90 is applied with the pressure in the direction away from the fitting surface 83. This reduces a pressure applied to the sealing member 90 between the inclined surface 68a and the fitting surface 83, and causes the sealing member 90 to move away from the fitting surface 83, which may decrease the sealing performance. In contrast, according to Embodiment 1, the pressing surface 68 does not have such a reversely inclined surface, and therefore the sealing member 90 is prevented from being applied with the pressure in the direction away from the fitting surface 83. Thus, the decrease in sealing performance can be prevented.

(4) While the latch 70 and the hole 85 are being brought into engagement with each other, when the latch 70 moves toward the hole 85, the latch 70 contacts the fitting surface 83 and causes the container main body 60 to deform so that the pressing surface 68 moves away from the fitting surface 83. When the latch 70 engages the hole 85, the container main body 60 resiliently restores its original shape so that the pressing surface 68 moves toward the fitting surface 83. With such a configuration, when the latch 70 engages the hole 85, the sealing member 90 is compressed by being sandwiched between the fitting surface 83 and the pressing surface 68. Therefore, the sealing member 90 is pressed against the fitting surface 83, and the sealing performance can be enhanced.

### MODIFICATIONS

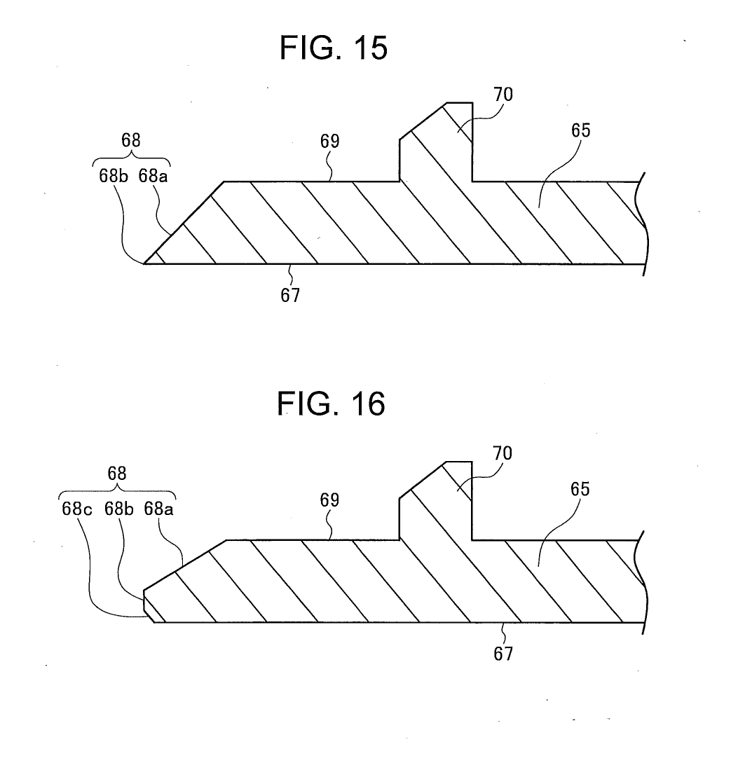

In the above description, the tip portion 68b of the pressing surface 68 is parallel to the surface of the sealing member 90. However, the tip portion 68b of the pressing surface 68 can have another shape. FIG. 15 shows a first modification of the pressing surface 68. In FIG. 15, the inner wall surface 67 and the inclined surface 68a are continuously formed. The tip portion 68b is configured as an acute-angled portion between the inner wall surface 67 and the inclined surface 68a.

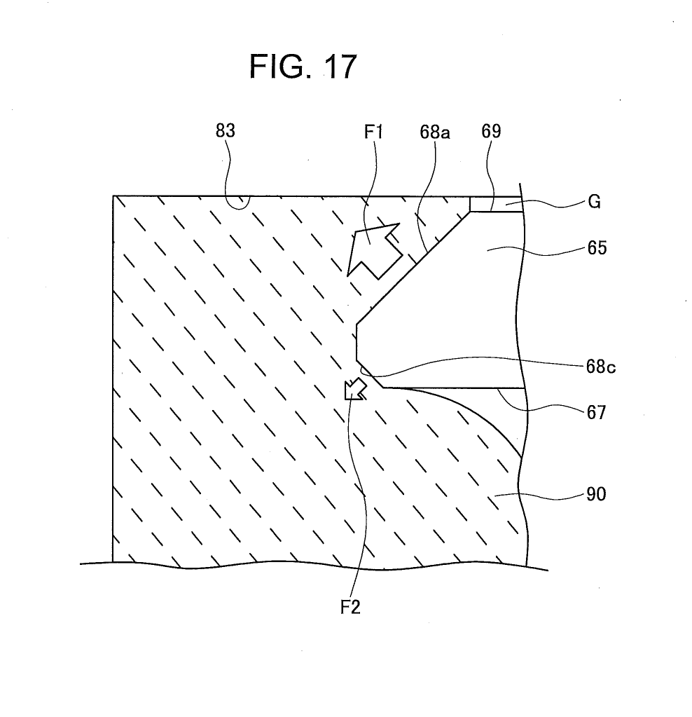

Further, in the above description, the pressing surface 68 does not have the reversely-inclined portion. However, it is also possible that the pressing surface 68 has the reversely-inclined portion. FIG. 16 shows a second modification of the pressing surface 68. In FIG. 16, the pressing surface 68 includes an inclined surface 68c (i.e., a second inclined surface) in addition to the inclined surface 68a (i.e., a first inclined surface). The inclined surface 68a is formed so as to face the fitting surface 83, and the inclined surface 68c is formed on a side opposite to the inclined surface 68a. The inclined surface 68c is inclined so that a distance between the inclined surface 68c and the fitting surface 83 decreases toward the opening 62. It is preferred that the inclined surface 68a has a larger area than the inclined surface 68c. With such an arrangement, as shown in FIG. 17, a force F1 applied to the sealing member 90 in a direction to increase a pressure (applied to the sealing member 90 between the fitting surface 83 and the inclined surface 68a) becomes larger than a force F2 applied to the sealing member 90 in a direction to reduce the pressure. Therefore, the pressure applied to the sealing member 90 between the fitting surface 83 and the inclined surface 68a can be increased, and the toner T is prevented from entering into the gap G between the fitting surface 83 and the outer wall surface 69.

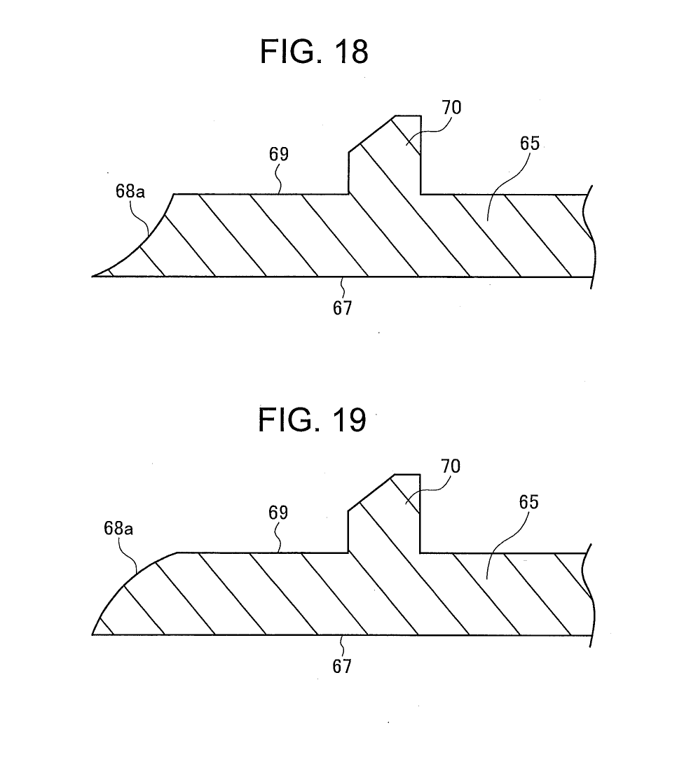

Further, in the examples shown in FIGS. 9 and 15, the inclined surface 68a of the pressing surface 68 is a flat surface. However, the inclined surface 68a can be a curved surface. FIGS. 18 and 19 show third and fourth modifications of the pressing surface 68. In FIG. 18, the inclined surface 68a of the pressing surface 68 is a curved convex surface. In FIG. 19, the inclined surface 68a of the pressing surface 68 is a curved concave surface.

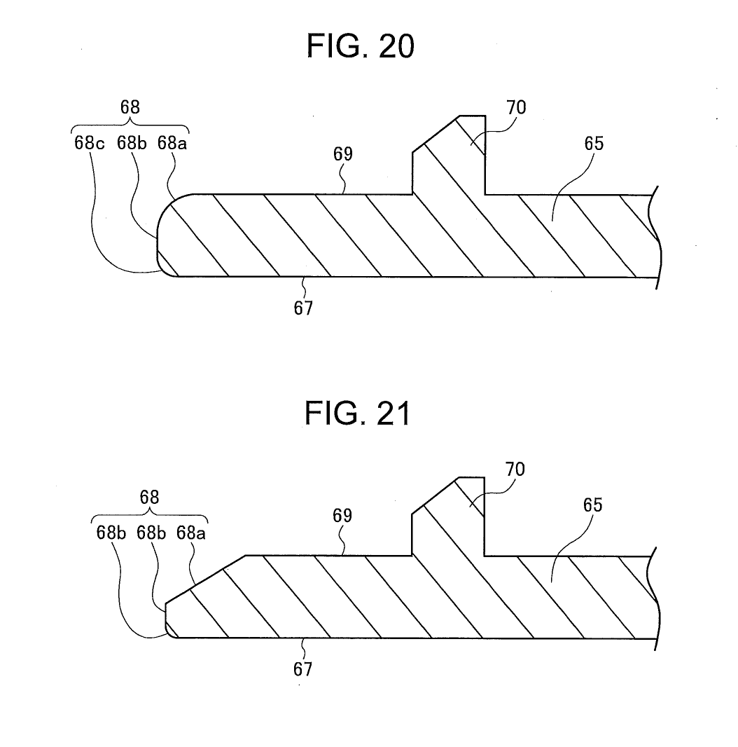

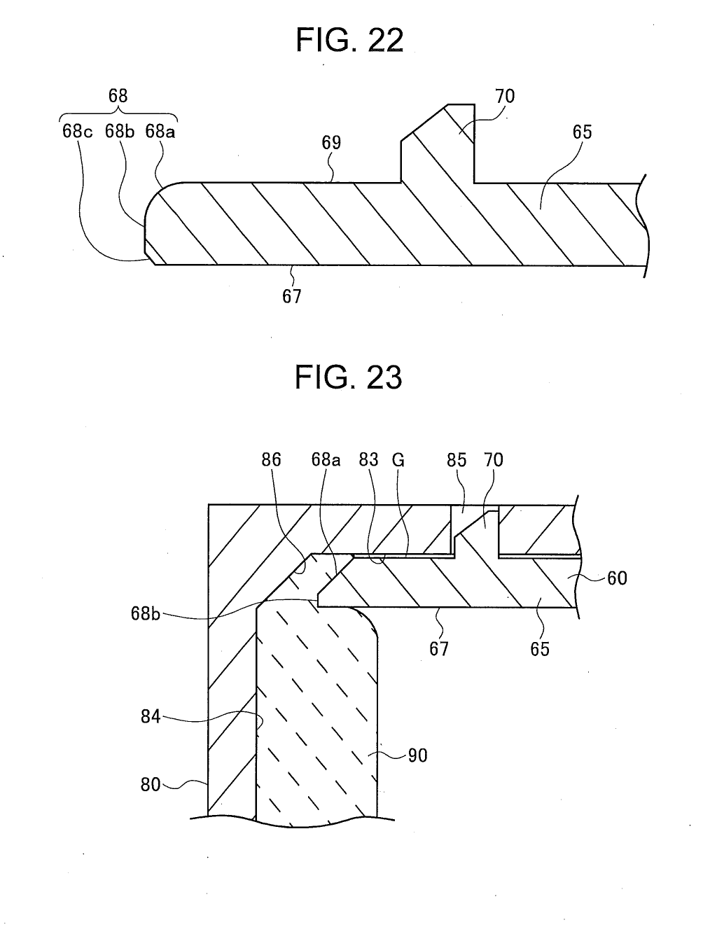

Further, in the example shown in FIG. 16, both of the inclined surfaces 68a and 68c are flat surfaces. However, the inclined surfaces 68a and 68c can be curved surfaces. FIG. 20 shows a fifth modification of the pressing surface 68. In FIG. 20, the inclined surfaces 68a and 68c of the pressing surface 68 are curved surfaces (more specifically, curved convex surfaces). FIGS. 21 and 22 show sixth and seventh modifications of the pressing surface 68. In FIG. 21, the inclined surface 68a is a flat surface, and the inclined surface 68c is a curved surface (more specifically, curved convex surfaces). In FIG. 22, the inclined surface 68a is a curved surface (more specifically, curved convex surfaces), and the inclined surface 68c is a flat surface. In the modifications (FIGS. 20 through 22) in which at least one of the inclined surfaces 68a and 68c is a curved surface, it is preferred that the inclined surface 68a has a larger area than the inclined surface 68c.

### Embodiment 2

Next, Embodiment 2 of the present invention will be described.

FIG. 23 is a schematic view showing a configuration of a fitting section N of a toner cartridge 50 according to Embodiment 2. The fitting section N shown in FIG. 23 corresponds to the fitting section N shown by the dashed line in FIG. 5. The toner cartridge 50 of Embodiment 2 is different from the toner cartridge 50 in that an inclined surface 86 is provided on the lid member 80. Other components of Embodiment 2 are the same as those of Embodiment 1. Hereinafter, components which are the same as those of Embodiment 1 are assigned the same reference numerals, and explanations thereof will be omitted or simplified.

As shown in FIG. 23, in Embodiment 2, the lid member 80 has the inclined surface 86 facing the inclined surface 68a of the container main body 60. The inclined surface 86 is inclined so that a distance between the inclined surface 86 and the fitting surface 83 decreases toward the container main body 60. In this example, the inclined surface 86 is provided between the fitting surface 83 and the bottom surface 84 so as to connect the fitting surface 83 and the bottom surface 84. Further, in this example, the inclined surface 86 is parallel to the inclined surface 68a of the container main body 60. Although the inclined surface 86 shown in FIG. 23 is a flat surface, the inclined surface 86 can be a curved surface.

According to Embodiment 2, the sealing member 90 is compressed between the inclined surface 68a and the inclined surface 86. Therefore, the sealing member 90 and the inclined surface 68a are pressed against each other with a higher pressure, as compared with a configuration in which the inclined surface 86 is not provided. Thus, the sealing performance can be enhanced.

### Embodiment 3

Next, Embodiment 3 of the present invention will be described.

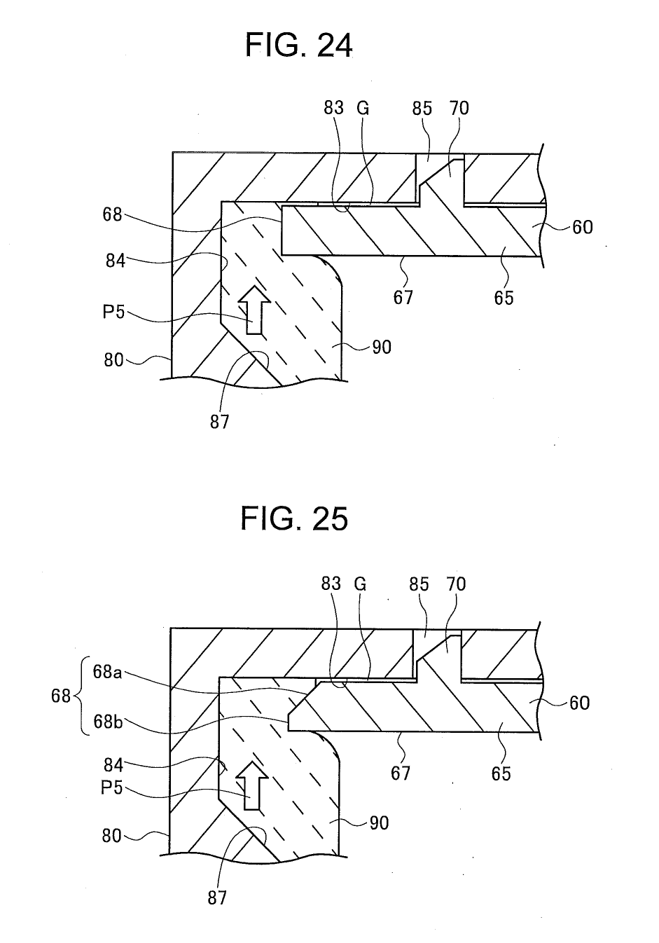

FIG. 24 is a schematic view showing a configuration of a fitting section N of a toner cartridge 50 according to Embodiment 3. The fitting section N shown in FIG. 24 corresponds to the fitting section N shown by the dashed line in FIG. 5. The toner cartridge 50 of Embodiment 3 is different from the toner cartridge 50 in that an inclined surface 87 is provided on the lid member 80. Other components of Embodiment 3 are the same as those of Embodiment 1. Hereinafter, components which are the same as those of Embodiment 1 are assigned the same reference numerals, and explanations thereof will be omitted or simplified.

As shown in FIG. 24, in Embodiment 3, the lid member 80 has the inclined surface 87 facing the fitting surface 83. The inclined surface 87 is inclined so that a distance between the inclined surface 87 and the fitting surface 83 increases toward the container main body 60. In this example, the inclined surface 87 is provided so as to protrude from the bottom surface 84 toward the container main body 60. Although the inclined surface 87 shown in FIG. 24 is a flat surface, the inclined surface 87 can be a curved surface.

In the example shown in FIG. 24, the pressing surface 68 of the container main body 60 does not have the inclined surface 68a. That is, the pressing surface 68 is a surface perpendicular to the fitting surface 83 (in other words, perpendicular to the fitting-in direction).

In Embodiment 3, when the sealing member 90 is compressed by being pressed by the pressing surface 68, the sealing member 90 is applied with a pressure P5 by the inclined surface 87 in a direction toward the fitting surface 83. With the pressure P5, the sealing member 90 is pressed against the fitting surface 83. Therefore, the sealing performance can be enhanced, as compared with the Comparison Example shown in FIG. 13.

Although the pressing surface 68 of FIG. 24 does not have the inclined surface 68a, it is also possible that the pressing surface 68 has the inclined surface 68a. FIG. 25 shows a modification of the fitting section N of the toner cartridge 50 according to Embodiment 3. In FIG. 25, the lid member 80 has the inclined surface 87, and the pressing surface 68 has the inclined surface 68a. Further, it is also possible to provide the inclined surface 87 to the lid member 80 of Embodiment 2.

In this specification, the term “parallel” is intended to mean generally or substantially parallel. Similarly, the term “perpendicular” is intended to mean generally or substantially perpendicular.

While the preferred embodiments of the present invention have been illustrated in detail, it should be apparent that modifications and improvements may be made to the invention without departing from the spirit and scope of the invention as described in the following claims.

For example, in the above description, the container main body 60 and the lid member 80 are fitted to each other or engaged with each other. However, it is also possible that the container main body 60 and the lid member 80 are fixed to each other using bonding or screws.

Further, in the above description, the printer has been described as an example of the image forming apparatus. However, the present invention is applicable to a copier, a facsimile machine, a MFP (Multi-Function Peripheral) or other image forming apparatus.

What is claimed is:

1. A developer storage container comprising:
a first storage member storing a developer;
a second storage member fitted to the first storage member; and
a sealing member that seals between the first storage member and the second storage member for preventing leakage of the developer,
wherein the first storage member includes a first fitting portion;
wherein the second storage member includes a second fitting portion fitted to the first fitting portion;
wherein the first fitting portion includes a pressing portion pressing the sealing member; and
wherein the pressing portion includes an inclined portion that faces the second fitting portion.

2. The developer storage container according to claim 1, wherein the inclined portion is inclined so that a distance between the inclined portion and the second fitting portion increases toward the sealing member.

3. The developer storage container according to claim 1, wherein the pressing portion includes a tip portion contacting the sealing member, and
wherein the tip portion extends in a direction substantially parallel to a surface of the sealing member in a state before the sealing member is deformed by being pressed by the pressing portion.

4. The developer storage container according to claim 1, wherein the first storage member includes a first engaging portion;
wherein the second storage member includes a second engaging portion that engages the first engaging portion; and
wherein the first engaging portion engages the second engaging portion in a state where the sealing member and the pressing member contact each other.

5. The developer storage container according to claim 4, wherein the first engaging portion protrudes from the first fitting portion; and
wherein a distance between the first fitting portion and the second fitting portion when the first storage member and the second storage member are fitted to each other is smaller than the distance between the first fitting portion and the second fitting portion while the first storage member and the second storage member are being fitted to each other.

6. The developer storage container according to claim 1, wherein the pressing portion does not includes an inclined portion which is inclined so that a distance between the inclined portion and the second fitting portion decreases toward the sealing member.

7. The developer storage container according to claim 1, wherein the inclined portion of the pressing portion is a first inclined portion;
wherein the pressing portion further includes a second inclined portion disposed on a side opposite to the first inclined portion; and
wherein the second inclined portion is inclined so that a distance between the second inclined portion and the second fitting portion decreases toward the sealing member.

8. The developer storage container according to claim 7, wherein the first inclined portion has a larger area than the second inclined portion.

9. The developer storage container according to claim 1, wherein the second storage member includes an inclined surface facing the inclined portion of the pressing portion; and
wherein the inclined surface is inclined so that a distance between the inclined surface and the second fitting portion decreases toward the first storage member.

10. The developer storage container according to claim 1, wherein the second storage member includes an inclined surface facing the second fitting portion; and
wherein the inclined surface is inclined so that a distance between the inclined surface and the second fitting portion increases toward the first storage member.

11. A developer storage container comprising:
a first storage member storing a developer;
a second storage member fitted to the first storage member; and
a sealing member that seals between the first storage member and the second storage member for preventing leakage of the developer,
wherein the first storage member includes a first fitting portion;
wherein the second storage member includes a second fitting portion fitted to the first fitting portion;
wherein the first fitting portion includes a pressing portion pressing the sealing member;
wherein the second storage member includes an inclined surface that faces the second fitting portion; and
wherein the inclined surface is inclined so that a distance between the inclined surface and the second fitting portion increases toward the first storage member.

12. A developer storage container comprising:
a storage member having an inner space storing a developer and an opening leading to the inner space;
a lid member provided on the storage member so as to open the opening; and
a resilient member provided between the storage member and the lid member so as to seal between the storage member and the lid member,
wherein the lid member includes a lid surface facing the opening and an extending surface extending from the lid surface toward the storage member;
wherein the resilient member is provided so as to contact the lid surface and the extending surface;
wherein the storage member includes an inner wall surface that extends toward the lid surface and defines the inner space, and a pressing surface formed continuously with the inner wall surface;
wherein the pressing surface contacts the resilient member so as to compress the resilient member between the storage member and the lid member; and
wherein the pressing surface includes an inclined surface facing the extending surface via the resilient member.

13. A developing device comprising:
the developer storage container according to claim 1; and
a developing member that develops a latent image using the developer supplied by the developer storage container.

14. An image forming apparatus comprising:
an image bearing body;
a latent image forming unit that forms a latent image on the image bearing body;
the developer storage container according to claim 1; and
a developing member that develops a latent image using the developer supplied by the developer storage container.
